(19) United States
(12) Patent Application Publication
(10) Pub. No.: US 2008/0275716 A1
(43) Pub. Date: Nov. 6, 2008

(54) SYSTEMS AND METHODS FOR PROVIDING AN ONLINE RENTAL HISTORY SYSTEM

(76) Inventor: Simon S. Kapenda, Westerville, OH (US)

Correspondence Address: Ruttler Law PLLC;One Union Square, 600 University Street, Suite 1919, Seattle, WA, 98101, US

(21) Appl. No.: 11/744,839

(22) Filed: May 5, 2007

(51) Int. Cl. G06Q 50/00

(52) U.S. Cl. 705/1

(57) ABSTRACT

This invention relates generally to an information portal, and more specifically, to systems and methods for providing an online rental history system. In one embodiment, the invention includes a method for providing an online rental history system, the method including the steps of creating a former landlord profile on a software application, the former landlord profile including identifying information for a former landlord; searching for a tenant profile on the software application using identifying information for a tenant; if the tenant profile exists, displaying the tenant profile on the software application; if the tenant profile does not exists, creating the tenant profile on the software application using the identifying information for the tenant; establishing a tenant rental record for the tenant profile on the software application, the tenant rental record including the identifying information for the former landlord and rental history information for a property; and publishing the tenant rental record on the software application, whereby the software application is accessible over a wide-area-network.

### FIELD OF THE INVENTION

This invention relates generally to an information portal, and more specifically, to systems and methods for providing an online rental history system.

### BACKGROUND

One of the bundles of rights that accompany property ownership is the right to rent out a property to others. This right is often manifested in the context of residential and commercial real property whereby the owner, a landlord, agrees to permit a tenant to occupy the property in consideration for periodic rental payments. Indeed, property rental arrangements date back thousands of years and are even referenced in The Bible. In modern times, property rental arrangements are widely prevalent and are becoming increasingly complex.

There are a host of concerns for any landlord that is considering renting out a property to a tenant. The foremost, of course, is whether a tenant will fulfill his or her end of the bargain and make timely rental payments. Also, the landlord is concerned as to whether a tenant will commit waste on a property or be a nuisance to others. These concerns are significant because once a landlord turns over possession of a property, residential and commercial tenant laws make it difficult to evict a tenant.

Likewise, there are a number of concerns for any tenant that is considering renting a property from a landlord. For instance, a tenant is concerned whether a landlord will keep the property in good condition and make timely repairs to damaged appliances or structures. Additionally, a tenant is concerned whether a landlord will request a tenant to prematurely vacate or unreasonably raise rent. These concerns are significant because occupying a property involves extensive labor, emotional, and monetary commitments.

Despite the important concerns by both landlords and tenants, only rudimentary tools have been developed to address them. For instance, when a tenant expresses an interest in a rental property the tenant usually fills out a rental history form. A landlord reviews the information provided and may conduct a credit check and attempt to contact former landlords. Of course, the tenant controls the disclosure and has an incentive to selectively omit damaging information. Furthermore, even when information is accurately disclosed it is difficult and time-consuming to manually research and contact former landlords. Oppositely, the tenant often has no information regarding the landlord and the landlord has virtually no incentive to disclose any information given the disparity in power. Astoundingly, based on this limited exchange of information, it is fairly common for a landlord and tenant to enter into a lengthy rental arrangement.

Accordingly, although advancements have been made there exists much room for improvement in the art. What is needed, then, are systems and methods for providing an online rental history system.

### SUMMARY

This invention relates generally to an information portal, and more specifically, to systems and methods for providing an online rental history system. In one embodiment, the invention includes a method for providing an online rental history system, the method including the steps of creating a former landlord profile on a software application, the former landlord profile including identifying information for a former landlord; searching for a tenant profile on the software application using identifying information for a tenant; if the tenant profile exists, displaying the tenant profile on the software application; if the tenant profile does not exists, creating the tenant profile on the software application using the identifying information for the tenant; establishing a tenant rental record for the tenant profile on the software application, the tenant rental record including the identifying information for the former landlord and rental history information for a property; and publishing the tenant rental record on the software application, whereby the software application is accessible over a wide-area-network.

### BRIEF DESCRIPTION OF THE DRAWINGS

Embodiments of the present invention are described in detail below with reference to the following drawings:

FIG. 1 is a block diagram of a system for providing an online rental history system, in accordance with an embodiment of the invention;

FIG. 2 is a block diagram of a method for establishing a tenant rental record in an online rental history system, in accordance with an embodiment of the invention;

FIG. 3 is a block diagram of a method for viewing a tenant rental record in an online rental history system, in accordance with an embodiment of the invention;

FIG. 4 is a block diagram of a method for disputing a tenant rental record and establishing a landlord record in an online rental history system, in accordance with an embodiment of the invention;

FIG. 5 is a block diagram of a method for disputing a landlord record in an online rental history system, in accordance with an embodiment of the invention; and

APPENDIX A is an example website incorporating various embodiments of the invention as described herein. APPENDIX A is provided for example purposes only and nothing described therein is intended to limit the invention in any way.

### DETAILED DESCRIPTION

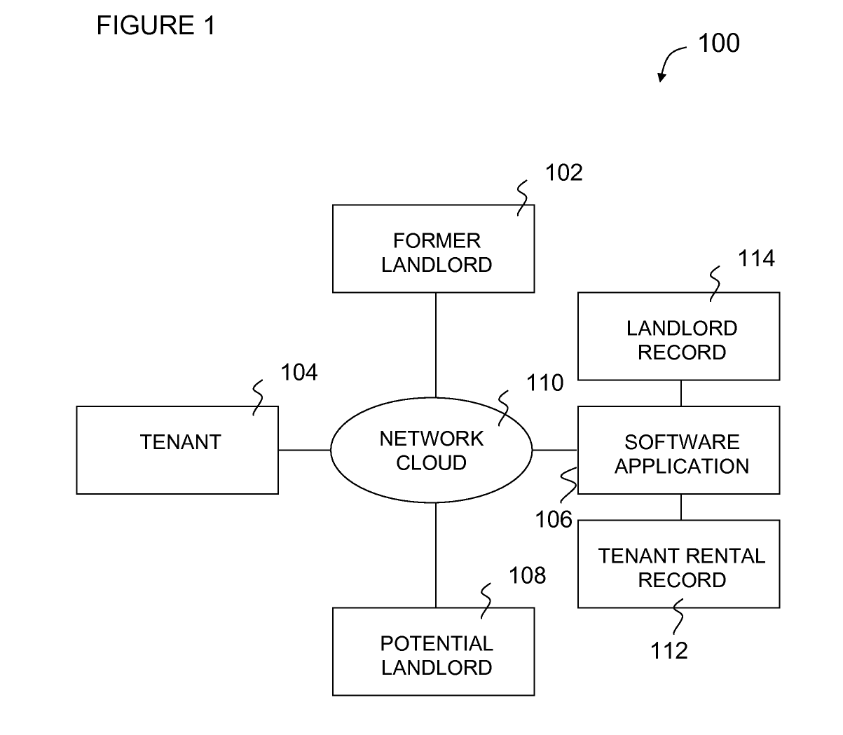

This invention relates generally to an information portal, and more specifically, to systems and methods for providing an online rental history system. Specific details of certain embodiments of the invention are set forth in the following description and in FIG. 1-5 and APPENDIX A to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a block diagram of a system for providing an online rental history system, in accordance with an embodiment of the invention. System 100 includes a software application 106 configurable to storing a tenant rental record 112 and a landlord record 114 and to being accessible to a former landlord 102, a potential landlord 108, and a tenant 104 over a network cloud 110.

In one embodiment, the software application 106 is accessible as one or more web pages and is written using languages such as HTML, JavaScript, AJAX, Flash®, Perl, ASP, .NET, Java®, and SQL; although other programming languages are employable and the software application can be non-web based. The software application can be deployed on one or more servers and can include database or third party software applications. The network cloud 110 is any public or private network such as the internet.

In one embodiment, the former landlord 102 is any current or former landlord of the tenant 104. The former landlord 102 accesses the software application 106 over the network cloud 110 to input the tenant rental record 112. The tenant rental record 112 relates to the tenant 104 and generally includes any information that would be important to the potential landlord 108 in making a decision to rent to the tenant 104.

In one embodiment, the potential landlord 108 is any landlord evaluating whether to rent property to the tenant 104. The potential landlord 108 accesses the software application 106 over the network cloud 110 to review the tenant rental record 112 and the information contained therein. The potential landlord 108 makes a decision to rent to the tenant 104 based, at least in part, on the tenant rental record 112.

In one embodiment, the tenant 104 is any entity that has rented from the former landlord 102 or is interested in renting from the potential landlord 108. The tenant 104 accesses the software application 106 over the network cloud 110 to review the tenant rental record 112. Upon review of the tenant rental record 112, the tenant 104 may notice an error or have a dispute and can use the software application 106 to request modification of the tenant rental record 112 by the former landlord 102. The former landlord 102 is notified of the request and can optionally modify the tenant rental record 112.

In one embodiment, the tenant 104 can establish the landlord record 114 by providing information to the software application 106 relating to the former landlord 102. The landlord record 114 generally includes information about the former landlord 102 that would be useful to another tenant (not illustrated) in making a decision to rent from the former landlord 102. The former landlord 102 can access the software application 106 to review the landlord record 114. Upon review of the landlord record 114, the former landlord 102 may notice an error or have a dispute and can use the software application 106 to request modification of the landlord record 114 by the tenant 104. The tenant 104 is notified of the request and can optionally modify the landlord record 114.

In certain embodiments, system 100 further includes capabilities to facilitate exchange of rental, for sale, and foreclosed properties.

Although system 100 has been described in reference to real property and a landlord/tenant relationship, system 100 can be applied to intellectual property and to other relationships including employer/employee relationships, company/independent contractor relationships, customer/business relationships, business/business relationships, romantic relationships, and purchaser/seller of real property relationships.

In one particular embodiment, system 100 provides a listing of rental properties and a referral fee program. A landlord can elect to participate in the referral fee program and a listing of the landlord's property will indicate such. Upon leasing the property using system 100, a tenant and any party referring the tenant will receive a referral fee award from the landlord. A portion of the referral fee award may be retained for profit.

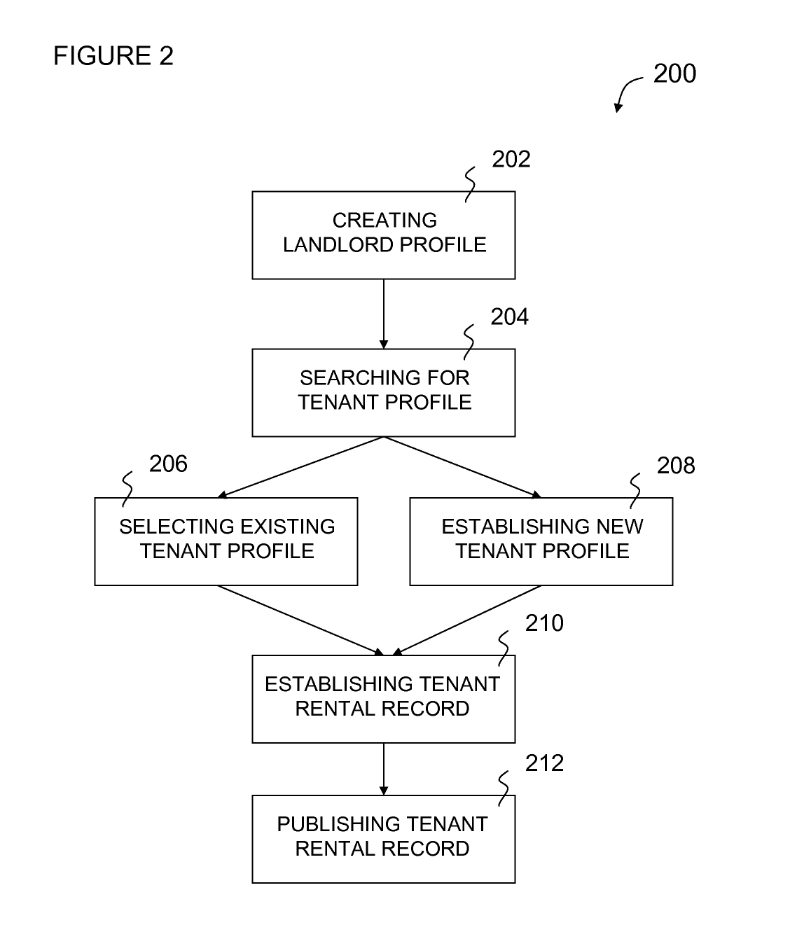

FIG. 2 is a block diagram of a method for establishing a tenant rental record in an online rental history system, in accordance with an embodiment of the invention. In one embodiment, method 200 includes creating a landlord profile at block 202, searching for a tenant profile at block 204, selecting an existing tenant profile at block 206 or establishing a new tenant profile at block 208, establishing a tenant rental record at block 210, and publishing the tenant rental record at block 212. Method 200 can be practiced using various embodiments described in reference to other figures.

In one embodiment, the creating a landlord profile at block 202 includes using a software application to provide information identifying a landlord. Such information can include, but is not limited to a landlord name, address, phone number, email, website, and address of any property owned. The landlord profile is usable to identify a source of information provided for a tenant rental record. The searching for a tenant profile at block 204 includes inputting tenant identifying information into the software application to determine whether a tenant profile already exists. Such tenant information can include, but is not limited to, a tenant name, social security number, date of birth, gender, mother's maiden name, and current address. The software application uses the tenant identifying information to search and provide any existing tenant profile. In one particular embodiment, security measures are established to prevent undesirable browsing of tenant profiles, such security measures can include requiring a social security number, date of birth, or a passcode. If there is an existing tenant profile, it is selected at block 206. If there is not an existing tenant profile, then a new tenant profile can be established at block 208 using the tenant identifying information, the new tenant profile being subsequently selectable. The establishing a tenant rental record at block 210 includes providing rental history information for the selected tenant profile. The rental history information can include, but is not limited to tenant name, occupancy address, number of occupants, number of bedrooms, a move-in date, a move-out date, whether proper notice was given, whether rent was timely paid, number of months late, number of pets, whether a property was maintained, tenant personal habits, a tenant personal attitude evaluation, a smoking status, whether disturbances occurred, whether police were called, a relationship status, whether eviction proceedings occurred, and comments. In certain embodiments, the rental history information can be limited to a simple recommendation or non-recommendation. The tenant rental record can further include public records, a credit report, a civil judgment report, a criminal background report, and a sexual offender report. In one particular embodiment, the tenant profile includes a numerical or categorical rating that accounts for a substantial amount of the information included therein. A tenant profile can contain tenant rental records for a plurality of landlords and properties. The publishing the tenant rental record at block 212 includes making the tenant rental record accessible to others for review.

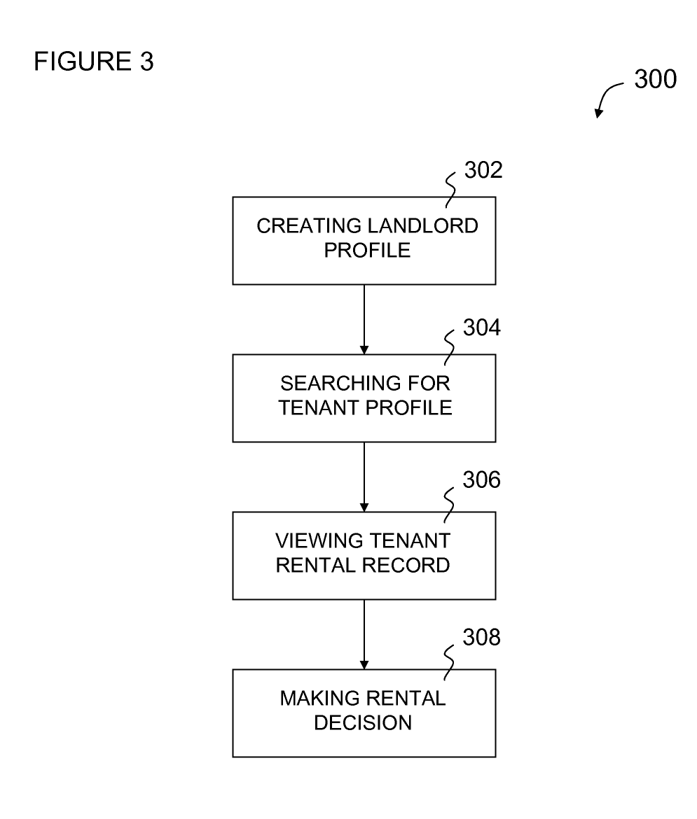

FIG. 3 is a block diagram of a method for viewing a tenant rental record in an online rental history system, in accordance with an embodiment of the invention. In one embodiment, method 300 includes creating a landlord profile at block 302, searching for a tenant profile at block 304, viewing a tenant rental record at block 306, and making a rental decision at block 308. Method 300 can be practiced with various embodiments as described in reference to other figures.

In one embodiment, the creating a landlord profile at block 302 includes using a software application to provide information identifying a landlord as described in reference to FIG. 2. The landlord profile is usable to identify who has viewed a tenant profile. The searching for a tenant profile at block 304 includes inputting tenant identifying information into the software application to locate a corresponding a tenant profile, also described in reference to FIG. 2. The viewing the tenant rental record at block 306 includes accessing the rental history information corresponding to the tenant profile, such rental history information having been provided at least in part by a former landlord as discussed in reference to FIG. 2. The rental decision at block 308 can be made at least in part by the rental history information.

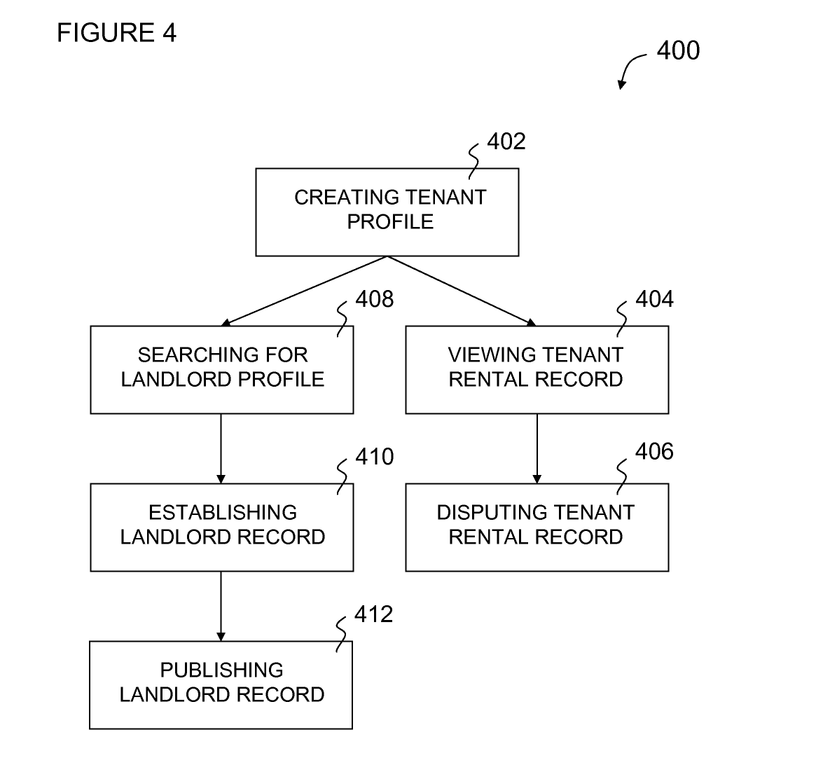

FIG. 4 is a block diagram of a method for disputing a tenant rental record and establishing a landlord record in an online rental history system, in accordance with an embodiment of the invention. In one embodiment, method 400 includes creating a tenant profile at block 402, viewing a tenant rental record at block 404, and disputing a tenant rental record at block 406. In another embodiment, method 400 includes creating a tenant profile at block 402, searching for a landlord profile at block 408, establishing a landlord record at block 410, and publishing the landlord record at block 412. Method 400 can be practiced with various embodiments as described in reference to other figures.

In one embodiment, the creating a tenant profile at block 402 includes using a software application to provide information identifying a tenant. Such information can include, but is not limited to, a tenant name, social security number, date of birth, gender, mother's maiden name, and current address. The tenant profile is usable to identify a source of information provided for a landlord record and is selectable by a landlord to establish or search for a tenant rental record as discussed in reference to FIGS. 2 and 3. The viewing a tenant rental record at block 404 includes accessing rental history information corresponding to the tenant profile provided by a former landlord as described in reference to FIG. 2. The disputing a tenant rental record at block 406 includes using the software application to identify errors or discrepancies in the tenant rental record. Any dispute is forwarded to the landlord that provided the tenant rental record, whereby the landlord can accept or reject the dispute. In one particular embodiment, if the landlord takes no action within a specified time period, then the requested modification to the tenant rental record automatically occurs.

In one embodiment, the searching for a landlord profile at block 408 includes inputting landlord identifying information into a software application to locate a corresponding a landlord profile. Such information can include, but is not limited to a landlord name, address, phone number, email, website, and address of any property owned. The software application uses the landlord identifying information to search and provide any existing landlord profile. An existing landlord profile can be selected. If there is not an existing landlord profile, then a new landlord profile can be established using the landlord identifying information, the new landlord profile being subsequently selectable. The establishing a landlord record at block 410 includes providing rental history information for the selected landlord profile. The rental history information can include, but is not limited to, average response time, rental price increase history, repair history, and comments. In one particular embodiment, the landlord profile includes an overall numerical or categorical rating that accounts for a substantial amount of the information included therein. Landlord records can be established for a plurality of tenants and properties. The publishing the landlord rental record at block 412 includes making the landlord record accessible to a potential tenant.

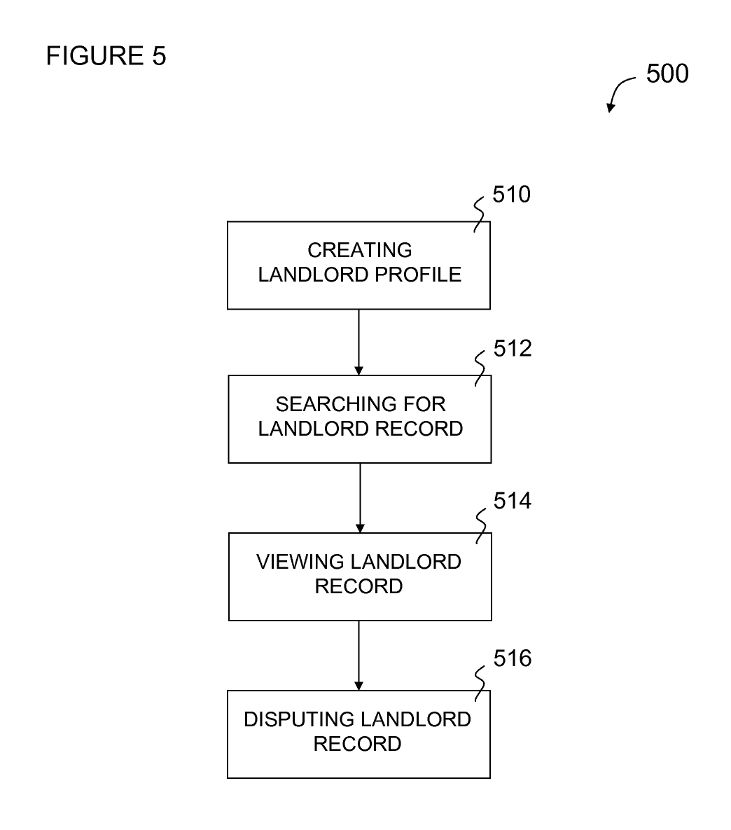

FIG. 5 is a block diagram of a method for disputing a landlord record in an online rental history system, in accordance with an embodiment of the invention. In one embodiment, method 500 includes creating a landlord profile at block 510, searching for a landlord record at block 512, viewing a landlord record at block 514, and disputing a landlord record at block 516. Method 500 can be practiced with various embodiments as described in reference to other figures.

In one embodiment, the creating a landlord profile at block 510 includes using a software application to provide information identifying a landlord as described in reference to FIG. 2. The viewing a landlord record at block 512 includes accessing the rental history information corresponding to the landlord profile provided by a tenant as discussed in reference to FIG. 4. The disputing a landlord record at block 516 includes using the software application to identify errors or discrepancies in the rental history information. Any dispute is forwarded to a tenant that provided the landlord record, whereby the tenant can accept or reject the dispute. In one particular embodiment, if the tenant takes no action within a specified time period, then the requested modification to the landlord record automatically occurs.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method for providing an online rental history system, the method comprising the steps of:
creating a former landlord profile on a software application, the former landlord profile including identifying information for a former landlord;
searching for a tenant profile on the software application using identifying information for a tenant;
if the tenant profile exists, displaying the tenant profile on the software application;
if the tenant profile does not exists, creating the tenant profile on the software application using the identifying information for the tenant;
establishing a tenant rental record for the tenant profile on the software application, the tenant rental record comprising the identifying information for the former landlord and rental history information for a property; and
publishing the tenant rental record on the software application, whereby the software application is accessible over a wide-area-network.

2. The method of claim 1, wherein the identifying information for the landlord comprises any of a landlord name, a landlord contact information, and an address of property owned by the landlord.

3. The method of claim 1, wherein the identifying information for the tenant comprises any of a tenant name, a tenant social security number, a tenant date-of-birth, a tenant gender, a tenant mother's maiden name, and a tenant current address.

4. The method of claim 3, wherein the identifying information for the tenant is required to be accurate before the displaying the tenant profile occurs.

5. The method of claim 1, wherein the rental history information further comprises any of an occupancy address, a number of occupants, a number of bedrooms, a move-in date, a move-out date, an indication of whether proper notice was given, an indication of whether rent was timely paid, an indication of a number of months rent was untimely paid, a number of pets owned, an indication of whether damage occurred, observable personal habits, an evaluation of attitude, a smoking status, an indication of whether a disturbance occurred, an indication of whether police were called, a relationship status, an indication of whether an eviction proceeding occurred, and a comment.

6. The method of claim 1, wherein the rental history information consists essentially of a binary recommendation of the tenant.

7. The method of claim 1, wherein the tenant rental record further comprises any of a credit report, a court judgment report, a criminal background report, and a sexual offender report.

8. The method of claim 1, further comprising the steps of:
searching for the tenant profile by a potential landlord on the software application using the identifying information for the tenant;
displaying the tenant profile on the software application, the tenant profile comprising the tenant rental record; and
making a decision to rent to the tenant based at least in part on the tenant rental record.

9. The method of claim 8, further comprising the step of:
creating a potential landlord profile on the software application, the potential landlord profile including identifying information for a potential landlord,
wherein the tenant profile is updated with the identifying information for the potential landlord to indicate that the potential landlord accessed the tenant profile.

10. The method of claim 1, further comprising the steps of:
searching for the tenant profile by the tenant on the software application using the identifying information for the tenant;
displaying the tenant profile on the software application, the tenant profile comprising the tenant rental record; and
disputing an aspect of the tenant rental record by the tenant on the software application, the disputed aspect being automatically forwarded to the former landlord for review.

11. The method of claim 10, wherein the disputed aspect is settled in favor of the tenant when there is no response from the former landlord within a given time period.

12. The method of claim 1, further comprising the steps of:
searching for the former landlord profile by the tenant on the software application using identifying information for the landlord;
establishing a former landlord rental record for the former landlord profile by the tenant on the software application, the former landlord rental record comprising the identifying information for the tenant and landlord history information for the property; and
publishing the former landlord rental record on the software application.

13. The method of claim 12, wherein the landlord history information comprises any of average response time, rental price increase history, repair history, and comments.

14. The method of claim 12, further comprising the steps of:
searching for the former landlord profile by the former landlord on the software application using the identifying information for the former landlord;
displaying the former landlord profile on the software application, the former landlord profile comprising the former landlord rental record; and
disputing an aspect of the former landlord rental record by the former landlord on the software application, the disputed aspect being automatically forwarded to the tenant for review.

15. The method of claim 14, wherein the disputed aspect is settled in favor of the former landlord when there is no response from the tenant within a given time period.
